(19) United States
(12) Patent Application Publication
(10) Pub. No.: US 2023/0130572 A1
(43) Pub. Date: Apr. 27, 2023

(54) Gas Purification and Liquefication System and Method Using Liquid Nitrogen

(71) Applicant: Chart Energy & Chemicals, Inc., Ball Ground, GA (US)

(72) Inventors: Catherine Dorsi, Houston, TX (US); Martin Knoche, Oberstammheim (CH); Andrea Macrellino, Castellanza (IT); Filippo Garuti, Treviolo (IT)

(21) Appl. No.: 18/048,947

(22) Filed: Oct. 24, 2022

Related U.S. Application Data
(60) Provisional application No. 63/271,388, filed on Oct. 25, 2021.

(51) Int. Cl. B01D 5/00; F25J 1/00; F25J 5/00

(52) U.S. Cl. CPC B01D 5/0075; F25J 1/0022; F25J 5/002; F25J 1/0035; B01D 5/009; B01D 2257/80; B01D 2257/504; B01D 2257/304; B01D 2257/702; B01D 2256/245; B01D 2256/10

(57) ABSTRACT

A system and method for cooling, purifying and liquifying a feed gas stream uses liquid nitrogen for cooling the system. After cooling the system, the warmed nitrogen is vented as a vapor. The system and method include a water condenser, a first and second cooler and a liquifier and production of at least first and second contaminant streams. Optionally, the system includes a compressor or blower and/or a separator.

### CLAIM OF PRIORITY

This application claims the benefit of U.S. Provisional Application No. 63/271,388, filed Oct. 25, 2021, the contents of which are hereby incorporated by reference.

### FIELD OF THE DISCLOSURE

The present disclosure relates generally to systems and methods for purifying and liquefying gas and, more particularly, to a system and method that purifies and liquefies gas using liquid nitrogen.

### BACKGROUND

Industrial gases, such as natural gas or other gases containing high levels of methane, are advantageously stored or transported in a liquid state because they occupy a much smaller volume (liquified natural gas for instance is 1/600^{th} the gaseous state). The liquified gases are then vaporized back to a gaseous state for use at a site or system.

Natural gas, biogas and other gases with high methane content are typically recovered with contaminants or impurities. Such contaminants or impurities may include water and carbon dioxide (CO₂). Further contaminants or impurities may include hydrogen sulfide (H₂S) or heavy hydrocarbons. These contaminants or impurities can negatively affect the liquification (such as by causing freeze up of the liquifying heat exchanger) and/or utilization of the gas. It is, therefore, important to remove as many of these contaminants or impurities as possible before liquefying and/or storing the gas for use.

Purification of such gases prior to liquefaction often involves a multi-step process that can have high equipment and operational costs. Increases in efficiency are desirable.

### SUMMARY OF THE DISCLOSURE

There are several aspects of the present subject matter which may be embodied separately or together in the methods, devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a system for purifying and liquefying a feed gas stream includes a water condenser having a cooling passage that receives the feed gas stream and cools the feed gas stream so that a cooled gas stream is formed. The water condenser also has a water outlet for removing liquid water from the water condenser. A first cooler has a first cooler cooling passage that further cools the cooled gas stream to separate a first contaminants stream. The first cooler has a first contaminants outlet for removing the first contaminants stream from the first cooler so that a partially purified cooled gas stream is produced. The first cooler further includes a first warming passage that receives a nitrogen stream, warms the nitrogen stream to cool the cooled gas stream and releases a nitrogen vapor stream through a first cooler nitrogen vapor stream outlet. A second cooler has a second cooler cooling passage that further cools the partially purified cooled gas stream to separate a second contaminants stream. The second cooler has a second contaminants outlet for removing the second contaminants stream from the second cooler so that a purified cooled gas stream is produced. The second cooler further includes a second warming passage configured to receive the nitrogen stream, warm the nitrogen stream so to further cool the partially purified cooled gas stream and release the warmed nitrogen stream through a second cooler nitrogen outlet. A liquifier has a liquifier cooling passage that liquifys the purified cooled gas stream and produces a liquid product. The liquefier further includes a liquefier warming passage that receives the nitrogen stream, warms the nitrogen stream so that the purified cooled gas stream is liquified and releases the warmed nitrogen stream through a liquefier nitrogen outlet.

In another aspect, a method for purifying and liquifying a feed gas stream includes the steps of: cooling the feed gas stream and removing liquid water to form a cooled gas stream; cooling the cooled gas stream in a first cooler and removing a first contaminant stream from the first cooler forming a partially purified cooled gas stream; cooling the partially purified cooled gas stream in a second cooler and removing a second contaminant stream from the second cooler to form a purified cooled gas stream; liquefying the purified cooled gas stream to form a liquid product and directing liquid nitrogen through the liquefier and second and first coolers to provide refrigeration therein.

### BRIEF DESCRIPTION OF THE DRAWINGS

FIG. 1 is a process flow diagram and schematic illustrating a first embodiment the purification and liquefaction system and method of the disclosure.

FIG. 2 is a process flow diagram and schematic illustrating a second embodiment of the purification and liquefaction system and method of the disclosure.

FIG. 3 is a process flow diagram and schematic illustrating a third embodiment the purification and liquefaction system and method of the disclosure.

FIG. 4 is a sectional view of a scraping heat exchanger embodiment suitable for use with the system and method of the disclosure.

FIG. 5a is a first schematic of a solids and liquids collection section suitable with use of the scraping heat exchanger of FIG. 4 or other scraping heat exchangers suitable for use with embodiments of the purification and liquefaction system and method of the disclosure.

FIG. 5b is a second schematic of the solids and liquids collection section of FIG. 5a.

### DETAILED DESCRIPTION OF EMBODIMENTS

In accordance with the present disclosure, liquid nitrogen is used to provide cooling to a gas purification and liquefication system. As explained below, the nitrogen may exit the system as a vapor stream.

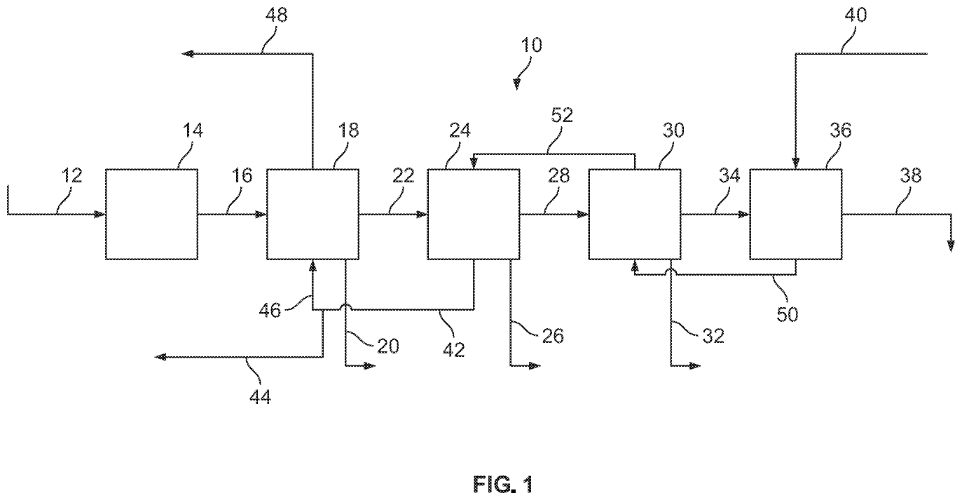

A process flow diagram and schematic illustrating a first embodiment of the gas purification and liquefication system and method of the disclosure is provided in FIG. 1.

It should be noted herein that the lines, conduits, piping, passages and similar structures and the corresponding streams are sometimes both referred to by the same element number set out in the figures. Also, as used herein, and as known in the art, a heat exchanger is that device or an area in the device wherein indirect heat exchange occurs between two or more streams at different temperatures, or between a stream and the environment. In addition, all heat exchangers referenced herein may be incorporated into one or more heat exchanger devices or may each be individual heat exchanger devices. As used herein, the terms “communication”, “communicating”, and the like generally refer to fluid communication unless otherwise specified. And although two fluids in communication may exchange heat upon mixing, such an exchange would not be considered to be the same as heat exchange in a heat exchanger, although such an exchange can take place in a heat exchanger. As used herein, the terms, “high”, “middle”, “warm”, “cold” and the like are relative to comparable streams, as is customary in the art.

As shown in FIG. 1, an initial feed gas stream 12, such as a raw biogas feed or natural gas feed, is compressed in compressor or blower 14 using one or more stages of compression or low-pressure blowers (as an example only, ˜9 bar compressor discharge). The compressor can consist of a single compressor or compressor stage or more than one compressor or compressor stage. The pressurized stream 16 is cooled (to ˜−5 to 40° C.) in a water condenser 18, and water is recovered via a free water knockout drum. Additional pretreatment steps may also be performed before or after cooler 18 as needed, and an additional cooling and/or water recovery may be performed after cooler 18. Liquid water in this step is removed in stream 20. Additional contaminant removal streams from any additional pretreatment steps are not shown. The remaining contaminants in cooled stream 22 will require further cooling to significantly below ambient temperature in order to condense, freeze, or desublimate contaminants for removal.

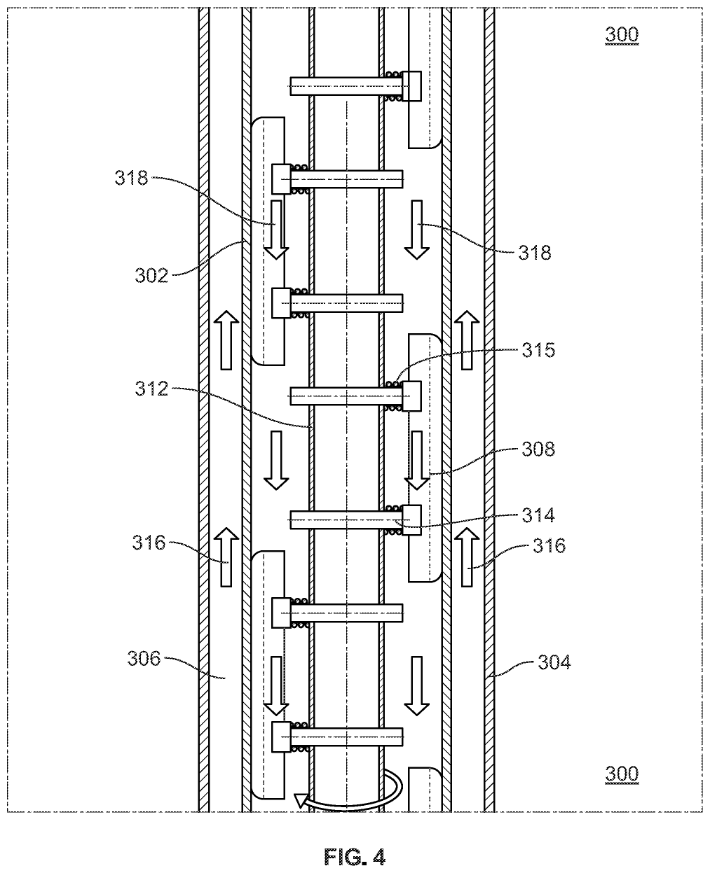

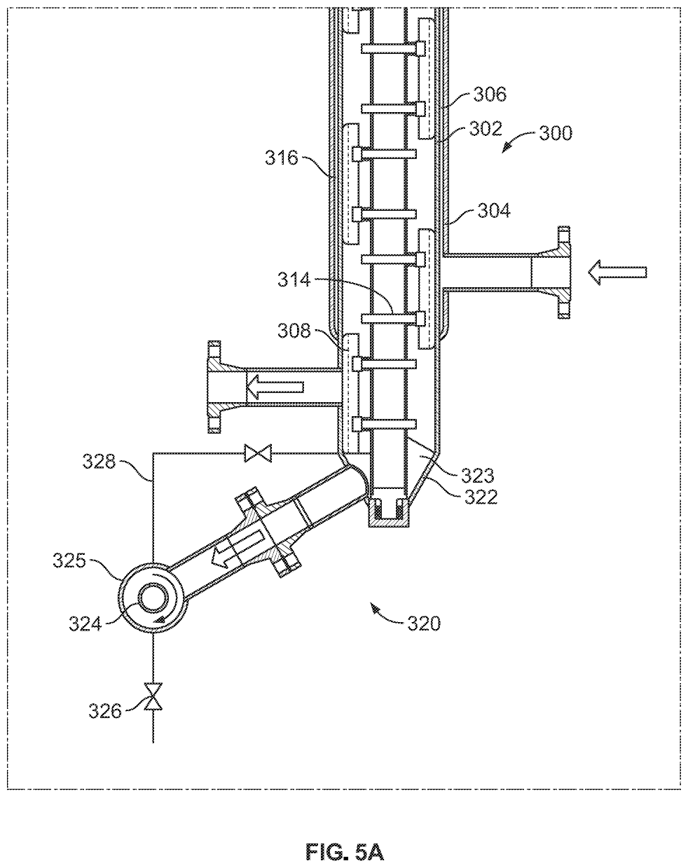

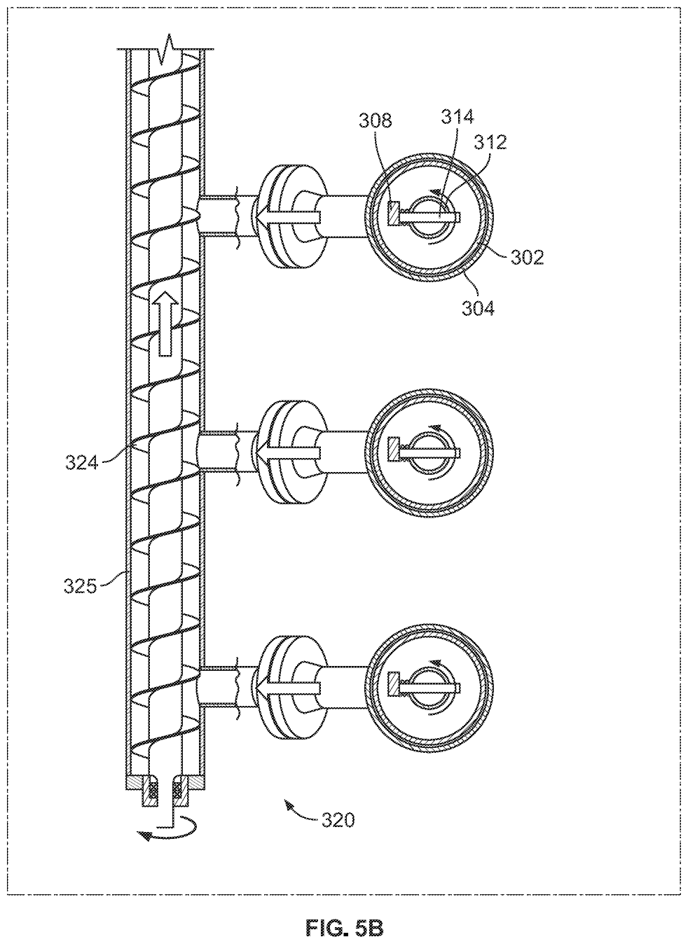

A first solid formation cooler or heat exchanger 24 receives stream 22 and will remove contaminants such as water in the form of solid ice. Heat exchanger 24 may have a mechanism for continuously scraping the heat exchange surfaces in order to remove the solids formed. Examples of such heat exchanger scrapers are provided below with reference to FIGS. 4 and 5. The solids removed by the scraper may be collected at the bottom of the heat exchanger for further processing. The solid ice is removed in first contaminant stream 26 either still in solid form or melted into liquid water. Partially purified cooled stream 28 exiting the heat exchanger 24 has very little of the contaminant removed by heat exchanger 24, such as water. Any remaining contaminants in stream 28 will need to be removed at a colder temperature. As examples only, stream 28 may have a pressure of ˜4 bar and a temperature of ˜−75° C.

A second solid formation cooler or heat exchanger 30 receives stream 28 and may be another solid formation cooler similar in design, though not necessarily identical, to that of heat exchanger 24. Another solid contaminant, such as CO₂ (dry ice) is removed in second heat exchanger 30. Remaining trace amounts of the contaminant removed in the first heat exchanger 24 may also solidify in heat exchanger 30. The solids may again be scraped from the heat exchange surfaces and collected at the bottom of the exchanger. The CO₂ contaminant is removed in a second contaminant stream 32 either in dry ice form, sublimated into vapor CO₂, or melted into liquid.

The remaining vapor leaving second heat exchanger 30 in purified cooled gas stream 34 may be relatively free of contaminants that would form solids above the bubble point of biomethane/natural gas and thus freezing in the liquefier 36. As examples only, stream 34 may have a pressure of ˜3 bar and a temperature of ˜−140° C. Liquefier 36, which may be a heat exchanger, liquefies the remaining vapor in stream 34 at a low or near atmospheric pressure. The liquid product known as liquefied biogas (LBG) or liquefied natural gas (LNG) is removed via stream 38 to a storage tank, tanker, or other transportation mode. As examples only, stream 38 may have a pressure of ˜2 bar and a temperature of ˜−165° C.

Pressurized liquid nitrogen enters the process via stream 40 and flows countercurrent to the vapor stream being purified and liquified. As examples only, the liquid nitrogen in stream 40 may have a pressure of ˜10 bar and a temperature of its bubble point of ˜−196° C. As an example only, the nitrogen may be sourced from an onsite liquid nitrogen tank that is able to be periodically refilled from a truck with liquid nitrogen purchased from a commercial supplier or other local sources. Liquefied waste nitrogen from a nearby air separation unit (ASU) or other device or system is another possible source of the liquid nitrogen.

The liquid nitrogen from stream 40 is warmed and vaporized as it flows through liquefier 36 as the vapor from stream 34 is liquified. The warmed nitrogen is further warmed as it passes through, and provides refrigeration in, second heat exchanger 30, and then first heat exchanger 24 via streams 50 and 52. The nitrogen stream is fully vaporized at or before it leaves first heat exchanger 24 via stream 42. As examples only, stream 42 may have a pressure of ˜2 bar and a temperature of ˜−21° C. The warm nitrogen vapor stream 42, which may still be below ambient temperature, can either be vented to a safe location via stream 44 or it can be routed via stream 46 to cooler 18 in order to supplement or replace air or water cooling within cooler 18. If the warm nitrogen is used in cooler 18, it will be further warmed and then vented to a safe location via stream 48.

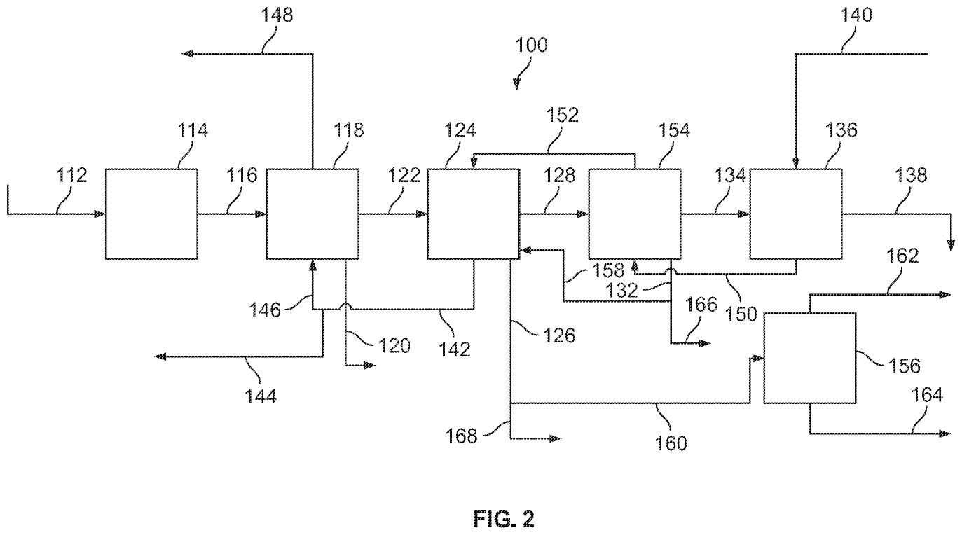

Turning now to the embodiment of FIG. 2, a blower or compressor 114, cooler 118, and a first solid formation cooler or heat exchanger 124 each may have construction and functionality similar to the corresponding components in FIG. 1. Furthermore, the embodiment of FIG. 2 features streams that are similar to the corresponding streams of FIG. 1, as reflected by their similar numbering, except as indicated below.

In FIG. 2, however, a second cooler or heat exchanger 154 is a liquid condensing heat exchanger instead of a solid forming heat exchanger. Here a contaminant contained in partially purified cooled stream 128 is condensed into liquid at a temperature below the freezing point of the solid contaminant in first heat exchanger 124. The liquid contaminant is removed from the second heat exchanger 154 via second contaminant stream 132 and can be sent for further processing via stream 166 or sent to first cooler or heat exchanger 124 via stream 158 to be used as a liquid carrier for the solids formed in first heat exchanger 124. Stream 158 may enter first heat exchanger 124 in the main heat exchanger section, the solids collection section, or any point downstream in the solids flow path.

If the liquid from second heat exchanger 154 is sent to first heat exchanger 124 then the liquid/solid slurry is removed via first contaminant stream 126 and stream 160 and may be further processed in separator 156 to produce first separate contaminant product stream 162 and second separate contaminant product stream 164. The separator 156, as in the case of any of the separators disclosed herein, may be an accumulation drum or any other separation vessel or other type of separation device known in the art including, but not limited to a cyclonic separator, a distillation unit, a coalescing separator or a mesh or vane type mist eliminator.

Potential separation methods that can be used in separator 156 will be obvious to one skilled in the art and may include filtering the solid contaminants such as ice from the liquid contaminant as well as boiling the liquid contaminant from the solid contaminant. Boiling can be accomplished through addition of heat and/or reduction of pressure. For some contaminant dispositions separation in separator 156 may not be necessary. Separator 156 may also include pumps, heat exchangers, and other equipment necessary to preform the separation of the two contaminants, as would be obvious to one skilled in the art.

To liquify CO₂ in second heat exchanger 154, the pressure may need to be above ˜5.1 bar and the temperature below ˜−56 C. In such an embodiment, all of the pressures and temperatures in stream 116, cooler 118, stream 122, first heat exchanger 124, and stream 128 would be higher than ˜5.1 bar and −56 C, or a compressor and possibly an air or water cooler could be placed along stream 128 between first heat exchanger 124 and second heat exchanger 154.

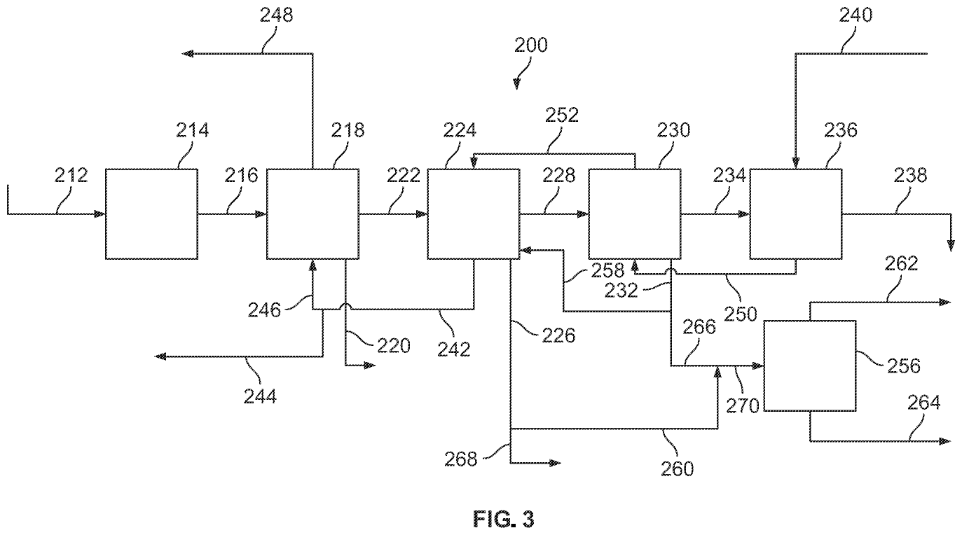

In the embodiment of FIG. 3, a first heat exchanger 224 is optional and, when present, is used to remove a third contaminant at the highest sub-ambient temperature as a solid or liquid. In such an embodiment, stream 228 may have two remaining contaminants which are recovered in second heat exchanger 230. Second heat exchanger 230 may again have a mechanism for scraping the heat exchange surfaces to remove solidified contaminants. One contaminant may form a solid and the other liquid in second heat exchanger 230 and a solid liquid slurry may be collected at the bottom of the heat exchanger. For example, second heat exchanger 230 may be configured such that water freezes from the vapor and CO₂ condenses out of the vapor. The solid liquid slurry may be removed via second contaminant stream 232. The slurry can be routed for further processing via stream 266 or to first heat exchanger 224 via stream 258 similar to first heat exchanger 124 and stream 158 in FIG. 2.

It is to be understood that the embodiment of FIG. 3 features streams that are similar to the corresponding streams of FIGS. 1 and 2, as reflected by their similar numbering, except as indicated below.

The liquid/solid slurry in stream 266 and/or a liquid/solid slurry stream 260 originally from cooler 224 may be sent via stream 270 to separator 256 for separation similar to that in separator 156. Separator 256 may produce first separate contaminant product stream 262 and second separate contaminant product stream 264.

To liquify CO₂ in second heat exchanger 230, the pressure may need to be above ˜5.1 bar and the temperature below ˜−56° C. Therefore, in this embodiment, all of the pressures and temperatures in stream 216, cooler 218, stream 222, first heat exchanger 224, and stream 228 would be higher than ˜5.1 bar and −56° C., or a compressor and possibly an air or water cooler could be placed along stream 228 between first heat exchanger 224 and second heat exchanger 230.

As noted previously, in some embodiments, it is desirable for the heat exchangers with solids formation to be continuously scraped while the gas is flowing to maintain a near constant heat transfer coefficient on the exchanger walls, with either periodic or continuous dumping of solids collected at the bottom. For removal of the solids scraped from the side of the exchangers, the bottom of the exchanger may open to a screw press that continuously packs the solids into a sealable chamber (with a closing door, gate, valve or similar) away from the exchanger such that vapor is kept out of the sealable chamber, and any heating would not affect the exchanger. In this case, the solids may be recovered and melted or sublimated in batches. Alternately, sealing may not be necessary, other than around the screw blades, allowing for continuous melting and/or sublimation of the removed solids in a chamber at the end of the screw press. Heating, possibly electric, of the screw blades may be used in some embodiments to prevent solids build-up.

Creating a liquid slurry, either by co-producing ice and liquid CO₂ in the same exchanger or washing the ice collected at the bottom of one exchanger with liquid CO₂ created elsewhere (either as melted dry ice or condensed from vapor) are also solutions to this. As another option, heating a sealing device or dump valve at the bottom of the exchanger to ensure proper opening and closing can be done. Some degassing might be necessary in this case if the solids aren't sufficiently packed at the bottom of the exchanger.

A sectional or cutaway view (taken along the longitudinal axis) of a portion of one potential configuration of a scraping heat exchanger suitable, indicated in general at 300, for use with the system and method of the disclosure is presented in FIG. 4. The heat exchanger includes an inner pipe 302 coaxial with and surrounded by an outer pipe 304 so that an annular space 306 is defined therebetween. The outer pipe 304 and other external portions of the exchanger or other process equipment may have external insulation, the design and application of which would be obvious to one skilled in the art. The process gas containing the contaminant(s) to be frozen and/or desublimated flow throughs the inner pipe 302 of a pipe-in-pipe exchanger. The coolant fluid flows through the annular space 306 between the inner and outer pipe walls. As an example only, the inner pipe 302 may be 6″ in diameter, or smaller or larger. Several of these pipe-in-pipe scraping heat exchangers may be combined in series or parallel to achieve sufficient flow rates and/or cooling and solids/liquids removal.

Scraper blades 308 are distributed along the length of a central axle 312 and are attached thereto by blade arms 314 in a fixed fashion so that all of the heat transfer surface of the inner wall may be scraped by the blades 308 when the central axle 312 is rotated. The blades and blade arms illustrated are not necessarily drawn to scale. The blades 308 may be attached perpendicularly or at an angle with regard to the central axle 312. Blades 308 are attached at multiple degrees of rotation around the axle 312 such that there are no two blades touching. The axle may be continuously rotated buy a motor, gears, or another method at one or both ends of the heat exchanger. The blades may rotate, for example at a 30-60 RPM, but faster and slower rotational speeds have been contemplated.

The scraper blades 308 can feature many alternative shapes including, but not limited to, triangular or rectangular. The blades 308 and their arms 314 may have an anti-stick coating, be made from anti-stick materials, be made in whole or in part from a polymer, and/or heated to prevent solids from sticking to the blades and ensured that the solids scraped from the inner wall of the inner pipe 302 drop to the bottom of the heat exchanger. The blades may or may not be spring loaded (optional springs illustrated at 315 in FIG. 4) with respect to the blade arms 314 and/or the axle 312. The springs may be coated in or fabricated from a non-stick material or covered in another material to prevent solids formation on the springs preventing proper operation of the springs. Additionally, the inner pipe wall 302 may be polished to reduce solids agglomeration.

Flow path arrows 316 and 318 indicate possible flow directions of the coolant and process gas flow, respectively, but may vary based on specific application needs. Indeed, the coolant and process gas flow directions may be opposite those indicated by arrows 316 and 318 in FIG. 4 or both in the same direction.

An embodiment of a solids and liquids collection section, indicated in general at 320, is presented schematically in FIGS. 5a and 5b. As illustrated in FIGS. 5a and 5b, the solids and liquids collection section 320 is positioned at the bottom of the scraping heat exchanger 300 of FIG. 4 so that solids and/or condensed liquids from heat exchanger 300 can be collected. Section 325 may collect solids and liquids of multiple exchanger configurations as in FIG. 5b. A conical shaped chute 322 may be used to guide liquids and solids scraped from the heat exchanger 300 into a screw 324 housed within a conduit 325 or similar device or method of conveying and packing the solids while also degassing. Conduit 325 may be attached directly to 322 or may have a section of solid collection pipe connecting 325 to 322. A rotating paddle 323 facilitates solid discharge from cone 322. The paddle may be made of the same material(s) as the blades or different material(s). The paddle may rotate continuously or intermittently as solids build up in the conical solids collection section 322. The solid screw 324 may be continuously rotated by a motor, gears, or other method at one or both ends. The screw 324 may be horizontal (as illustrated), vertical, or at some angle in between.

Further non-limiting details and/or non-limiting screw press designs for the screw 324 and housing 325 arrangement may be found in U.S. Patent Application Publication No. US20180172346A1 to Baxter et al. and U.S. Patent Application Publication No. US20180170784A1 to Baxter et al., the contents of both of which are hereby incorporated by reference.

After all the solids are compacted and effectively degassed, solids and any collected liquids can be removed from conduit 325 through a valve 326 or other openable sealing mechanism. The valve or sealing mechanism may be normally open or may open and close as needed to ensure that only packed, degassed solids and/or liquids are removed from that location.

A valved line 328 (illustrated in FIG. 5a) from the screw section to any other portion of the process side of the heat exchanger 300 can be used to degas during start up and pressure balance between the solids and gas sections.

Any portion of the solids collection section such as the walls, screw, valve or sealing mechanism may have an anti-stick coating, be made from anti-stick materials, be made in whole or in part from a polymer, and/or be heated to prevent solids from sticking and clogging this section.

Furthermore, solid scraping of heat exchangers has been previously described in the art, particularly in U.S. Pat. No. 10,780,460 and European application no. EP3791125A1, each of which are incorporated by reference in their entirety. European application no. EP3791125A1 describes a condensate extraction device for a heat exchanger, including a condensate drain opening and a lock device having a condensate collection chamber wherein the lock device can be arranged in a collection position and in a drain position. U.S. Pat. No. 10,780,460 describes a heat exchanger with a cylindrical tube with guiding grooves and a lead screw with a cleaning element in which a rotating movement of the lead screw moves the cleaning element in the axial direction along the guiding grooves.

It is possible to recover a partially pure water stream under certain configurations and conditions. However, if some hydrates are expected to form in the water freezing cooler, the melted water stream can be recycled to the liquid section of one or more compressor knockout drums or free water knockout drums to allow the methane trapped as hydrate to be recovered. Frozen water or hydrate in the CO₂ recovery stream (liquid or solid) may require additional processing, depending on the disposition of the CO₂ stream. If the maximum amount of water is removed in an exchanger prior to the exchanger which removes CO₂, then the contamination of water and hydrates in the CO₂ stream should be minimal and may not require removal for most dispositions of CO₂.

It is possible and may be desirable to include pressure drops, such as by Joule-Thomson (JT) or other expansion valves or devices, along the path of the gas being purified and liquefied. For example, such expansion devices may be included at streams 22, 28, 34, and 38 and/or streams 50, 52, and 42 and/or corresponding streams in FIGS. 2 and 3.

If the recovered solid and/or liquid contaminants are not required to be maintained at cold temperatures for their final sale or disposition, the recovered streams maybe heat integrated into any of the cooling steps.

While first and second coolers and a single water condenser are illustrated, the number of coolers and condensers may vary from what is illustrated in the above embodiments.

In the above embodiments, a refrigerant loop is not necessary, with the systems using only liquid nitrogen and air/water cooling. All cooling below what can be achieved with air/water cooling is done with liquid nitrogen, but the liquid nitrogen can also be used for higher temperature cooling. Pressurized liquid nitrogen enters the liquefier first, and is vaporized in the liquefier, at least partially, and then the nitrogen continues to the coldest stage of cooling and freeze out. Once the nitrogen is fully vaporized it continues to cool the gas feed stream as the nitrogen warms. In the above embodiments, the nitrogen cooling should be sufficient to remove the desired impurities as either solid or liquid and still be cold enough to provide some additional cooling near ambient temperatures.

While the preferred embodiments of the disclosure have been shown and described, it will be apparent to those skilled in the art that changes and modifications may be made therein without departing from the spirit of the disclosure, the scope of which is defined by the following claims.

What is claimed is:

1. A system for purifying and liquefying a feed gas stream comprising:
a. a water condenser having a cooling passage configured to receive the feed gas stream and cool the feed gas stream so that a cooled gas stream is formed, said water cooler also having a water outlet for removing liquid water from the water cooler;
b. a first cooler having a first cooler cooling passage configured to further cool the cooled gas stream to separate a first contaminants stream, said first cooler having a first contaminants outlet for removing the first contaminants stream from the first cooler so that a partially purified cooled gas stream is produced, said first cooler further including a first warming passage configured to receive a nitrogen stream, warm the nitrogen stream to cool the cooled gas stream and release a nitrogen vapor stream through a first cooler nitrogen vapor stream outlet;
c. a second cooler having a second cooler cooling passage configured to further cool the partially purified cooled gas stream to separate a second contaminants stream, said second cooler having a second contaminants outlet for removing the second contaminants stream from the second cooler so that a purified cooled gas stream is produced, said second cooler further including a second warming passage configured to receive the nitrogen stream, warm the nitrogen stream so to further cool the partially purified cooled gas stream and release the warmed nitrogen stream through a second cooler nitrogen outlet; and
d. a liquifier having a liquifier cooling passage configured to liquify the purified cooled gas stream and produce a liquid product, said liquefier further including a liquefier warming passage configured to receive the nitrogen stream, warm the nitrogen stream so that the purified cooled gas stream is liquified and release the warmed nitrogen stream through a liquefier nitrogen outlet.

2. The system of claim 1 wherein the water condenser is configured to receive the nitrogen vapor stream for cooling and vent the warmed vapor.

3. The system of claim 1 further comprising a compressor or blower for increasing the pressure of the feed gas stream before entering the cooler.

4. The system of claim 1 further comprising a contaminant separator having a first outlet and a second outlet, said contaminant separator configured to receive the first contaminants stream from the first cooler and produce a first separate contaminant product that exits the contaminant separator through a first outlet and a second separate contaminant product that exits the contaminant separator through a second outlet.

5. The system of claim 4, wherein the contaminant separator is further configured to receive the second contaminants stream from the second cooler.

6. The system of claim 4, wherein the first cooler is further configured to receive at least a portion of the second contaminants stream from the second cooler.

7. The system of claim 1, wherein the water condenser cools the feed gas stream to about −5° C. to 50° C.

8. The system of claim 1, wherein the first cooler is a first heat exchanger.

9. The system of claim 8, wherein the first heat exchanger is a first solid forming heat exchanger and the first contaminant stream is a solid contaminant stream and wherein the first heat exchanger further comprises a solid scraping mechanism for removing the solid contaminants from heat exchanging surfaces of the first heat exchanger.

10. The system of claim 1, wherein the second cooler is a second heat exchanger that is a second solid forming heat exchanger and the second contaminant stream is a solid contaminant stream.

11. The system of claim 10, wherein the second heat exchanger further comprises a solid scraping mechanism for removing the solid contaminants from the heat exchanging surfaces.

12. The system of claim 8, wherein the second cooler is a second liquid condensing heat exchanger.

13. The system of claim 1, wherein the first cooler is a first liquid condensing heat exchanger.

14. A method for purifying and liquifying a feed gas stream comprising the steps of:
a. cooling the feed gas stream and removing liquid water to form a cooled gas stream;
b. cooling the cooled gas stream in a first cooler and removing a first contaminant stream from the first cooler forming a partially purified cooled gas stream;
c. cooling the partially purified cooled gas stream in a second cooler and removing a second contaminant stream from the second cooler to form a purified cooled gas stream;
d. liquefying the purified cooled gas stream to form a liquid product; and
e. directing liquid nitrogen through the liquefier and second and first coolers to provide refrigeration therein.

15. The method of claim 14 further comprising the steps of:
f. directing the first contaminant stream to a contaminant separator;
g. separating the first contaminant stream into a first contaminant product and a second contaminant product.

16. The method of claim 15 further comprising the steps of:
h. directing the second contaminant stream to a contaminant separator; and
i. separating the second contaminant stream into a third contaminant product and fourth contaminant product.

17. The method of claim 14, wherein step a. is performed using a water condenser and further comprising the steps of directing gaseous nitrogen from the first cooler to the water condenser and venting nitrogen vapor.

18. The method of claim 14 further comprising the steps of compressing or blowing the feed gas stream prior to cooling the feed gas stream in step a.

19. The method of claim 14 wherein the feed gas contains methane.

20. The method of claim 14 wherein the first contaminant stream contains water and wherein the second contaminant stream contains water, carbon dioxide, hydrogen sulfide and/or heavy hydrocarbons.
